(19) United States
(12) Patent Application Publication
(10) Pub. No.: US 2008/0065313 A1
(43) Pub. Date: Mar. 13, 2008

(54) AUTOMOBILE FUEL-SAVING MECHANISM

(76) Inventor: Kuo-Neng CHEN, Taichung City (TW)

Correspondence Address: EGBERT LAW OFFICES, 412 MAIN STREET, 7TH FLOOR, HOUSTON, TX, 77002, US

(21) Appl. No.: 11/937,440

(22) Filed: Nov. 8, 2007

Related U.S. Application Data
(63) Continuation-in-part of application No. 11/470,197, filed on Sep. 5, 2006.

(51) Int. Cl. G06F 19/00

(52) U.S. Cl. 701/123

(57) ABSTRACT

The present invention provides an auto fuel-saving mechanism, which enables a fuel-saving computer to be linked between an auto engine computer and an inlet sensor. The signals sensed by inlet sensor can be properly processed by the fuel-saving computer for decrement and then input to the auto engine computer. After the auto engine computer receives decrement signals input from the fuel-saving computer, the calculated AFR (Air-Fuel Raito) is smaller than theoretical AFR=14.7:1, thus serving the purpose of fuel-saving and exhaust emission reduction.

### CROSS-REFERENCE TO RELATED U.S. APPLICATIONS

The present application is a continuation-in-part of U.S. patent application Ser. No. 11/470,197, filed on Sep. 5, 2006, and entitled “FUEL-EFFICIENCY COMPUTER SYSTEM FOR CARS”, presently pending.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an auto fuel-saving mechanism, and more particularly to an innovative mechanism employing a fuel-saving computer to change AFR (Air-Fuel Ratio) controlled by an auto-engine computer, so that the automobile can run at a lower AFR (14.7:1) to save fuel and reduce exhaust emission.

2. Description of Related Art Including Information Disclosed Under 37 CFR 1.97 and 37 CFR 1.98.

Human beings now face the challenges of an oil crisis, including soaring oil prices and subsequent air pollution with growing oil consumption. Fuel expense accounts for the biggest share of the average monthly costs of the general public, who have to bear price hikes and air pollution.

To minimize fuel consumption and to save costs for consumers, some fuel-saving mechanisms have been developed. But, IR and magnetic wave devices in typical fuel-saving mechanisms cannot really satisfy customer's fuel-saving requirements and make contributions to improvement of air pollution.

A typical patent publication in relation to the subject matter of the present invention is “Engine Operation and Injection Control Method” of U.S. Publication No. US2006/0260294 A1. Referring to FIG. 1 (prepared from the views of the prior art publication), sensors 2, 3 are separately assembled in front of and behind the catalytic converter 1. The sensors are also linked to a control module 4. When the engine is accelerated, the two sensors 2, 3 can sense and send the signals to the control module 4, which orders a fuel system 5 to inject fuel for improving deflagration and increasing the horsepower of engine. However, this prior art invention leads to higher fuel consumption while the horsepower of engine is improved.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The fuel-saving computer is assembled between an inlet sensor and auto engine computer. The signals originally input by the inlet sensor to the auto engine computer are processed by fuel-saving computer, so that the auto engine computer can receive these signals from the fuel-saving computer, and then calculate AFR of the auto engine for lowering to less than a theoretical AFR of 14.7:1. Thus, the fuel-saving computer can monitor the signals of the inlet sensor according to engine load and rotational speed, and then output the decrement signals to the auto engine computer to calculate a lower AFR without affecting the running speed and horsepower. In such a case, the auto engine computer can receive decrement signals and reduce properly the fuel supply, helping to save fuel and reduce exhaust emission.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of a typical prior art automobile fuel-saving mechanism.

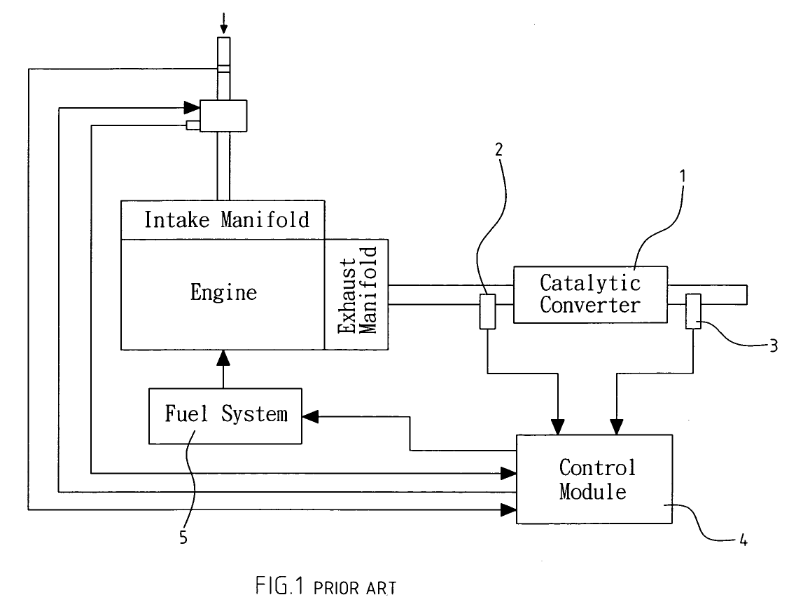

FIG. 2 shows a schematic view of an illustration of a block diagram of the flow process of auto fuel-saving computer of the present invention.

FIG. 3 shows a schematic view of an illustration of a sensor of the auto fuel-saving computer of the present invention.

FIG. 4 shows another schematic view of an illustration of the sensor of the auto fuel-saving computer of the present invention.

FIG. 5 shows still another schematic view of an illustration of the sensor of the auto fuel-saving computer of the present invention.

FIG. 6 shows a graph illustration of the signal decrement of the auto fuel-saving computer of the present invention.

FIG. 7 shows a graph illustration of a curve diagram of the signal decrement of the auto fuel-saving computer of the present invention.

FIG. 8 shows a graph illustration of the correlation of the oxygen-bearing sensor's output signal versus AFR.

FIG. 9 shows graph illustration of a representation of theoretical AFR.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

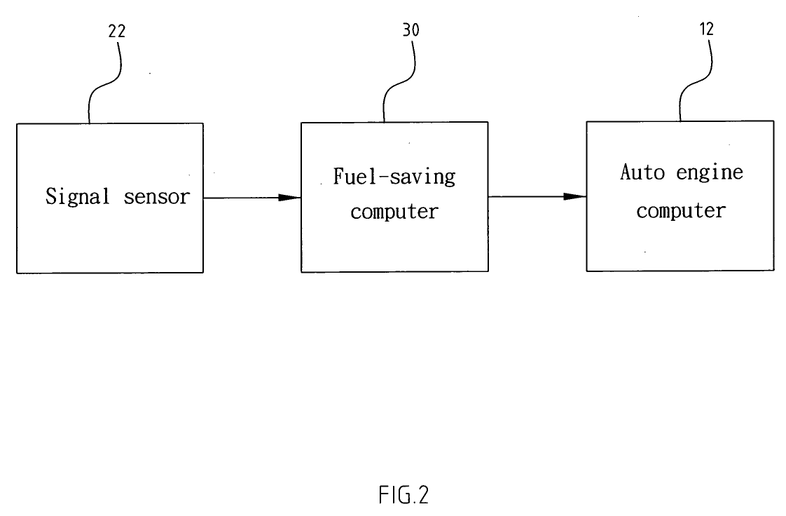

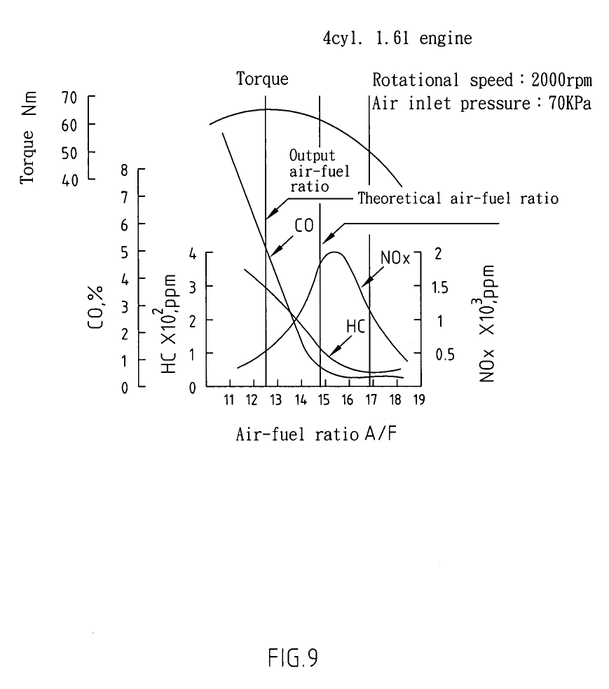

FIGS. 2-9 depict preferred embodiments of an auto fuel-saving mechanism of the present invention. The embodiments are provided only for explanatory purposes for the patent claims.

The auto fuel-saving mechanism includes an auto engine computer 12, which is assembled at a preset location within the carriage or engine room. The auto engine 10 contains at least an intake manifold 13, a gas exhaust pipe 14, a piston cylinder 15, an air filter 16 and a throttle 17. The auto engine computer 12 has a program for controlling AFR into a theoretical AFR of 14.7:1. The default value of AFR will vary from the running load of auto engine 10, and can be recovered by an oxygen-bearing signal controller 20.

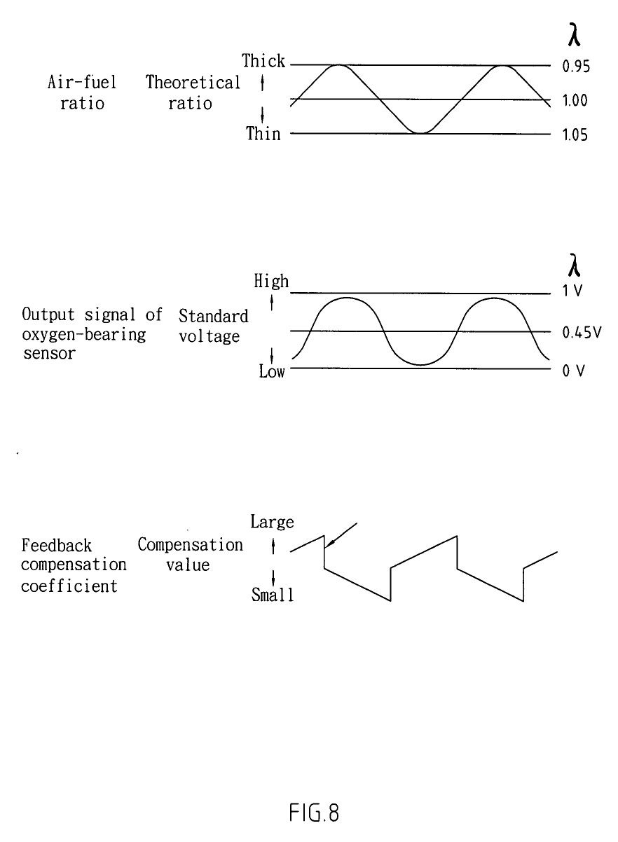

As shown in FIG. 8, the oxygen-bearing sensor will output a voltage signal from 0.1V to 0.9V, and then to 0.1V, depending on auto engine computer AFR=14.7:1. The output is based on the interaction between auto engine computer 12 and oxygen-bearing sensor 21. This voltage signal will generate 4-6 fluctuations in 10 s, and the time-dependent voltage fluctuation is simulated by the fuel-saving computer.

An oxygen-bearing sensor 21 is assembled onto gas exhaust pipe 14 of auto engine 10 and used to detect oxygen-bearing content in gas exhaust pipe 14 and to convert the information into a signal. The oxygen-bearing signals are transmitted through a signal line 210.

An inlet sensor 22 is assembled at a preset location of the intake manifold 13 of auto engine 10, used to detect the airflow or pressure of intake manifold 13 of auto engine 10, or the opening angle of throttle. Then, the information is converted into signals.

A fuel-saving computer 30 is assembled between said oxygen-bearing sensor 21, inlet sensor 22 and auto engine computer 12, and linked to the signal line 220 of inlet sensor 22. The fuel-saving computer 30 is fitted with an oxygen-bearing simulation signal output line 201. The signal from the oxygen-bearing signal output line 201 is sent to auto engine computer 12 at AFR=14.7:1, so that the auto engine computer 12 may not provide a higher fuel delivery in fuel-saving mode. An inlet sensing signal output line 202 is linked to auto engine computer 12. The fuel-saving computer 30 can receive and process properly the signals from inlet sensor 22, and then input to auto engine computer 12.

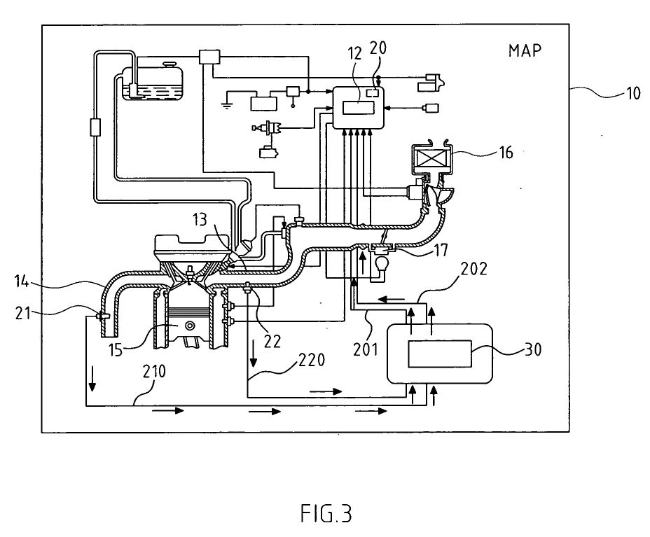

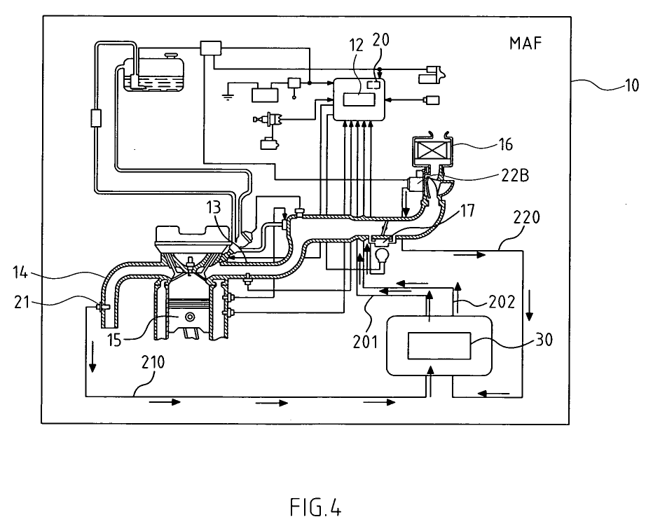

The signals from said oxygen-bearing sensor 21 can be transmitted to fuel-saving computer 30 through the signal line 210. So, oxygen-bearing signals can be sent to auto engine computer 12 at AFR=14.7:1 under a fuel-saving mode, as shown in FIGS. 3 and 4.

Based upon above-specified components, the signals originally input by inlet sensor 22 to auto engine computer 12 are processed by fuel-saving computer 30, so that auto engine computer 12 can receive these signals from fuel-saving computer 30, and calculate lower AFR of auto engine. Thus, the fuel-saving computer 30 can monitor the signals of inlet sensor 22 according to engine load and rotational speed, and then output the decrement signals to auto engine computer to calculate AFR without affecting the running speed and horsepower. In such a case, auto engine computer 12 can receive decrement signals and reduce properly the fuel supply, helping to save fuel and reduce exhaust emission.

Referring to FIG. 3, said inlet sensor 22 is an Intake Manifold Absolute Pressure Sensor (IMAP sensor), which is assembled onto intake manifold 13 of auto engine 10 to detect the pressure state of intake manifold 13.

Referring to FIG. 4, said inlet sensor 22B is an Intake Manifold Air Flow Sensor (IMAF sensor), which is assembled onto a location of intake manifold 13 nearby air filter 16 to detect the flow state of inlet air.

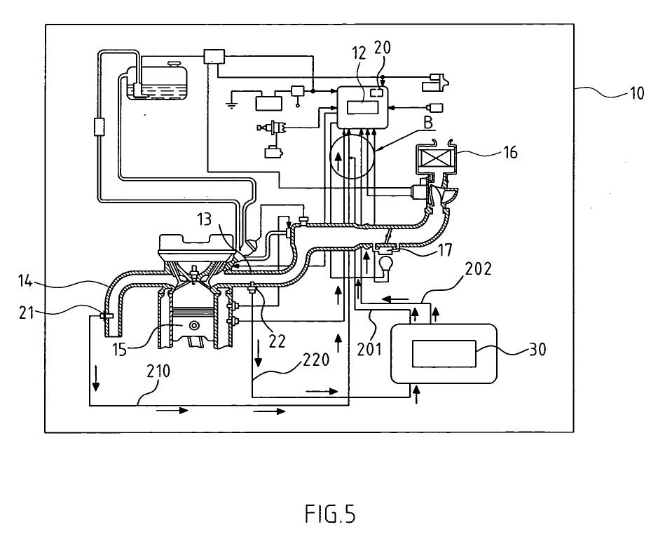

FIG. 5 depicts another preferred embodiment of the present invention, which is another assembly mode of oxygen-bearing sensing signal line of IMAP as shown in FIG. 3. The signals output by oxygen-bearing sensor 21 are directly transmitted via signal line 210 to auto engine computer 12. The oxygen-bearing signal output line 201 (AFR=14.7:1) of fuel-saving computer 30 is assembled onto the signal line 210 (shown in B of FIG. 5). In the case of the fuel-saving mode, the fuel-saving computer 30 transmits oxygen-bearing signal (AFR=14.7:1) to auto engine computer 12 through oxygen-bearing signal output line 201. Since the signal level of oxygen-bearing signal output line 201 is bigger than that of oxygen-bearing sensor 21, auto engine computer 12 can read oxygen-bearing signals of AFR=14.7:1 provided by fuel-saving computer 30. This configuration is also suitable for IMAF as shown in FIG. 4.

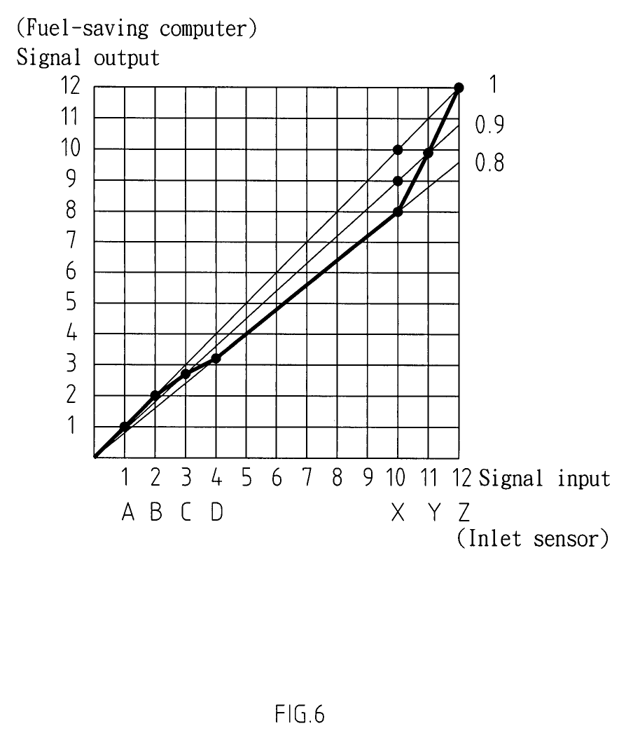

FIG. 6 depicts a view of signal decrement of auto fuel-saving computer of the present invention, wherein the value represented by horizontal coordinate is signal input of inlet sensor 22, and that represented by longitudinal coordinate is signal output of fuel-saving computer 30 (preferred embodiments hereunder). There are three oblique lines in the coordinate, of which the upper one represents rate of slope=1, and the middle and lower ones represent rate of slope=0.9, 0.8; the rate of slope represents the rate of signal decrement conducted by fuel-saving computer 30. Point A in the horizontal coordinate represents the low-speed signals after startup. Output signals cannot be reduced at low speed, and the signals shall be output at a theoretical AFR=14.7:1, otherwise the rotational speed of engine is unstable. The oblique line above point A has a rate of slope=1, so the signal quantity of fuel-saving computer 30=signal quantity of point A×1.

Fuel-saving computer 30 will detect automatically maximum signal quantity at point Z. At this time, the engine is in high-speed, high load and a quick acceleration state without signal decrement by fuel-saving computer 30, and the signal quantity of inlet sensor 22 is output to auto engine computer 12. After capturing point A, Z, the fuel-saving computer 30 calculates point B from point A. Point A-B is a signal range for maintaining reliable low-speed operation of the engine during switching-on the lamp, air conditioning and kickdown. Point A-B has a rate of slope=1; and the signal quantity of fuel-saving computer 30=signal quantity of point A-B×1 without decrement. The fuel-saving computer 30 calculates point C from point A. The signal range of B-C indicates light load and a slightly rising speed of engine, the signal quantity of point C increases slightly than point B, so fuel-saving computer 30 makes a slight decrement at a ratio by multiplying 1-0.9. The fuel-saving computer 30 calculates point D from point A, and the signal range of point C-D indicates the state of light load. The signal quantity of point D increases slightly more than point C, so the fuel-saving computer 30 makes a slight decrement at a ratio by multiplying 0.9-0.8.

The fuel-saving computer 30 point Y from point Z, of which point Y indicates signal quantity of high load, high horsepower or rotational speed, so the fuel-saving computer 30 makes a slight decrement at a ratio by multiplying 0.9-1. The fuel-saving computer 30 calculates point X from point Z, of which point X indicates high load and high horsepower, with a smaller load than Y, so the fuel-saving computer 30 makes decrement of signal at a ratio by multiplying 0.8-0.9. Point D-X indicates the signal range of common running load, and the fuel-saving computer 30 makes a decrement of signal at a percentage by multiplying 0.8. For the above-specified signal decrement, the signal quantity in the fuel-saving range can be established by fuel-saving computer 30 through automatic learning, and loaded into the memory of fuel-saving computer 30 for judgment and calculation. Alternatively, the signal decrement in the fuel-saving range can be pre-loaded into the memory of fuel-saving computer 30.

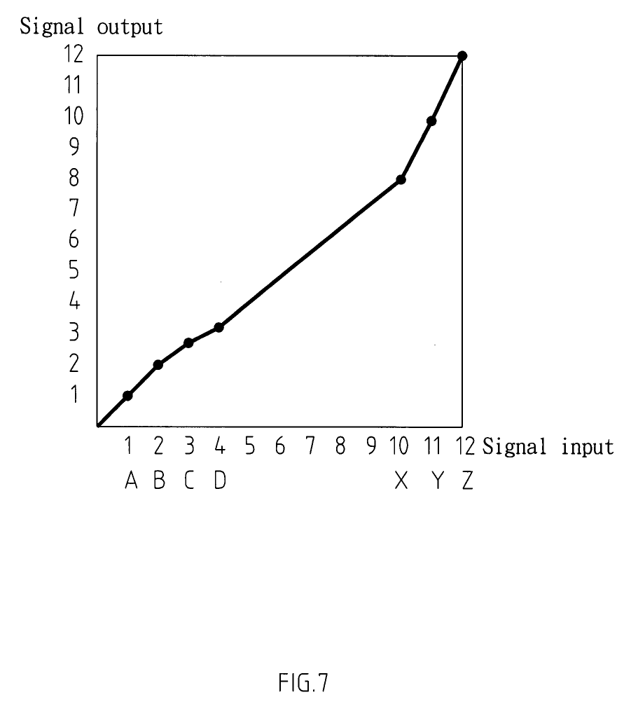

FIG. 7 depicts a signal decrement curve diagram of the present invention. The fuel-saving computer 30 of the present invention detects continuously the signals of inlet sensor 22 at a frequency of 0.3 s. If the signal of inlet sensor 22 rises over 50% within 0.3 s, it indicates that the automobile is accelerated with higher horsepower, so the fuel-saving computer 30 outputs signal of inlet sensor 22 by 1:1 without decrement. Thus, when the automobile is required to accelerate with higher horsepower during the running process (e.g. overtaking, climbing and acceleration), the fuel-saving computer 30 will judge automatically and stop signal decrement output in tune with acceleration, high-speed and high-load running state.

1. An auto fuel-saving mechanism, comprising:
an auto engine computer, being assembled at a preset location within a carriage or engine room and being linked to an auto engine, said auto engine being comprised of at least an intake manifold, a gas exhaust pipe, a piston cylinder, an air filter and a throttle, said auto engine computer has having a program of controlling AFR into a theoretical AFR=14.7:1, a default value of AFR being variable from running load of said auto engine and recoverable by an oxygen-bearing signal controller;
an oxygen-bearing sensor, being assembled onto said gas exhaust pipe of said auto engine, oxygen-bearing content in gas exhaust pipe being detected and converted into a signal by said oxygen-bearing sensor transmitting oxygen-bearing signals through a signal line;
an inlet sensor, being assembled at a preset location of said intake manifold of said auto engine, said intake manifold of said auto engine having an airflow or pressure detected by said inlet sensor, said throttle having an opening angle detected by said inlet sensor, said airflow or pressure and said opening angle being converted into signals; and
a fuel-saving computer, being assembled between said oxygen-bearing sensor, inlet sensor and said auto engine computer and being linked to a signal line of said inlet sensor, said fuel-saving computer being fitted with an oxygen-bearing simulation signal output line and an inlet sensing signal output line linked to said auto engine computer, said signals from said inlet sensor being received and processed by said fuel-saving computer and being input to said auto engine computer after decrement,
wherein said signals from said inlet sensor to said auto engine computer are processed by fuel-saving computer, said auto engine computer receiving decrement signals from said fuel-saving computer, said auto engine having a lower AFR calculated, said signals from said inlet sensor being monitored by said fuel-saving computer according to engine load and rotational speed, said decrement signals being output from said fuel-saving computer to said auto engine computer to calculate AFR without affecting running speed and horsepower, said auto engine computer receiving decrement signals and reducing fuel supply.

2. The mechanism defined in claim 1, wherein said signal line of said oxygen-bearing sensor is assembled into said fuel-saving computer, and then into said auto engine computer via an output line.

3. The mechanism defined in claim 1, wherein said signal line of said oxygen-bearing sensor is assembled into said auto engine computer, and wherein said output line of said fuel-saving computer is linked to said signal line.

4. The mechanism defined in claim 1, wherein said inlet sensor is an Intake Manifold Absolute Pressure Sensor, and assembled onto said intake manifold of said auto engine to detect a pressure state of said intake manifold.

5. The mechanism defined in claim 1, wherein said inlet sensor is an intake airflow sensor, and assembled at a location of said intake manifold nearby an air filter to detect flow state of said inlet air.

6. The mechanism defined in claim 1, wherein said inlet sensor is a throttle position sensor, and assembled onto said throttle of said oxygen manifold of said auto engine and having a signal quantity of an opening angle of said throttle detected by said throttle position sensor.

7. The mechanism defined in claim 1, wherein said fuel-saving computer detects continuously the signals of inlet sensor; if a signal of inlet sensor exceeds a setting value within a preset time, said auto engine is accelerated with higher horsepower, said fuel-saving computer outputting a signal of said inlet sensor to said auto engine computer without decrement.

8. The mechanism defined in claim 1, wherein said fuel-saving computer establishes said signal decrement through automatic learning, said signal decrement being loaded into memory of said fuel-saving computer for judgment and calculation, said signal decrement in a fuel-saving range being preloaded into memory of said fuel-saving computer.
